(19) United States
(12) Patent Application Publication
(10) Pub. No.: US 2008/0042425 A1
(43) Pub. Date: Feb. 21, 2008

(54) Method of Producing and Cutting Relatively Small Elements, Corresponding Devices, Elements and Sheets Comprising Such Elements

(75) Inventors: Didier Gouelibo, Cernay La Ville (FR); Didier Souchet, Chateaudun (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: ARJOWIGGINS SECURITY, Issy Les Moulineaux (FR); ETIVOL, Chateaudun (FR)

(21) Appl. No.: 10/589,001

(22) PCT Filed: Feb. 11, 2005
(86) PCT No.: PCT/FR05/00335

§ 371 Date: Jul. 2, 2007

(30) Foreign Application Priority Data
Feb. 11, 2004 (FR) 0401329

(51) Int. Cl. B42D 15/00

(52) U.S. Cl. 283/85; 101/483; 283/95; 83/39; 83/505

(57) ABSTRACT

The invention relates to a method for manufacturing elements of relatively small size, especially such as planchettes, comprising the following steps:
a wound sheet is unwound, then
optionally, this sheet is printed at least partly on at least one side and then
the sheet is cut deeply “right through” along a succession of at least two cutting patterns that intersect so as to constitute a resulting pattern that will form a detached element constituting the element of relatively small size, this cutting operation taking place by means of a succession of synchronized cutting cylinders carrying one of the cutting patterns respectively, anvil cylinders being interposed between these cutting cylinders, the sheet passing between all these cylinders and
the detached elements that form said elements of relatively small size are recovered.
   It also relates in particular to the method of cutting out said elements, to the corresponding devices, to said elements and to the sheet containing them. Application to security or decorative elements and to security-protected or decorative papers.

The invention relates to a method of manufacturing elements of relatively small size, such as planchettes, and in particular to the cutting method and to the corresponding devices. The invention also relates to said elements thus obtained and to the fibrous sheets containing them.

In security documents there are security elements of small size called planchettes, allowing the documents to be authenticated. These planchettes are similar to confetti, usually of circular or hexagonal shape. They may include authentication agents. To manufacture security papers or papers for bank notes containing planchettes, the latter are introduced into the aqueous dispersion containing cellulose fibers, optionally synthetic fibers and other additives usually employed in papermaking. When the aqueous suspension is drained on the wire of a cylinder mold or Fourdrinier paper machine, a number of planchettes are located on the surface of the paper sheet thus formed, which is then dried.

The sheet may also relate to the decorative field, the planchettes then being of decorative use.

Security sheets or documents with planchettes are described for example in the patents EP 342 929, EP 546 917, EP 544 611 and U.S. Pat. No. 4,037,007.

These planchettes are currently produced on a flat sheet by a sequential stamping process using punches or barbs. The sheets are plastic sheets and/or paper sheets of low basis weight. When they are based on a paper sheet, this is in general called an overlay sheet, normally used as protective sheet in the field of decorative laminated papers. This sheet is conventionally manufactured by draining an aqueous suspension of cellulose fibers refined to a low degree, of about 20° SR (Schoepper-Riegler), containing a wet-strength agent and having a low basis weight of around 25-40 g/m².

Since the stamping process is slow and the sheets used are thin, about 50 to 100 μm thickness, several stacked sheets, usually three or four sheets, are in general stamped.

One drawback is that the sheets undergo deformation during stamping, especially the underneath sheets, thereby creating irregular planchettes.

Another drawback is that it is difficult to change the shape of the punches or barbs as these are plates made as a single piece.

Another drawback is there has to be a sufficient space between the punches or barbs so that the sheet is properly held in place during stamping, which results in a substantial loss of sheet, the more so as the sheet is an expensive sheet as it includes printing, other security elements and authentication agents.

Another drawback is that the larger the size of the planchettes, the more difficult the stamping becomes. Current planchettes are limited in size to about 1.5 mm.

One drawback is that their small dimensions do not allow clearly visible and/or legible text or patterns to be printed. One drawback is therefore this stamping method does not allow planchettes of larger size to be easily provided.

The objects of the invention are to solve the abovementioned drawbacks.

The objects are achieved by proposing a novel method of manufacturing elements of relatively small size and in particular a novel cutting method.

The invention proposes a method for manufacturing elements of relatively small size, especially such as planchettes, comprising the following steps:
a wound sheet is unwound, then
optionally, this sheet is printed at least partly on at least one side and then
the sheet is cut deeply “right through” along a succession of at least two cutting patterns that intersect so as to constitute a resulting pattern that will form a detached element constituting the security element, this cutting operation taking place by means of a succession of synchronized cutting cylinders carrying one of the cutting patterns respectively, anvil cylinders being interposed between these cutting cylinders, the sheet passing between all these cylinders and
the detached elements that form said elements of relatively small size are recovered.

Preferably, all the steps are carried out in line, and preferably at a speed of between 20 and 150 m/min.

The wound sheet is a sheet of paper, a sheet of nonwoven, a sheet of plastic or a complex of these materials i.e. a paper/plastic, paper/nonwoven, plastic/nonwoven or paper/plastic/nonwoven complex, in any order. In particular, the plastic is a polyester.

According to one particular case of the invention, the sheet is printed by flexography.

According to one particular case of the invention, the sheet is printed in an amount of 1 to 10 g/m² per side, preferably between about 2 and 5 g/m² per side, by dry weight.

According to one particular case of the invention, the sheet is printed on only one side.

According to one particular case of the invention, the sheet is printed on both its sides in succession by front/back registration, in particular by turning the sheet over or by reversing the rotation of a printing unit.

Preferably, the sheet has a thickness of between about 50 and 110 μm.

According to one particular case of the invention, the detached elements are recovered by stripping, in particular using a peel bar and suction.

According to one particular case of the invention, the largest dimension of the detached element is between 0.5 and 6 mm, preferably between 1 and 4 mm.

The invention also relates to the method of cutting itself. This method of cutting out elements of relatively small size, especially such as planchettes, is characterized in that, starting from a sheet, said sheet is cut deeply “right through”, continuously, along a succession of at least two cutting patterns that intersect so as to constitute a resulting pattern that will form a detached element constituting the element of relatively small size, this cutting operation taking place using a succession of synchronized cutting cylinders carrying one of the cutting patterns respectively, anvil cylinders being interposed between these cutting cylinders.

The invention also relates to the deep cutting device (“right through”). This device for cutting out elements of relatively small size, especially such as planchettes, is characterized in that it comprises a rotary cutting device comprising a succession of synchronized cutting cylinders having respective cutting threads, anvil cylinders being interposed between these cutting cylinders, the cutting threads on the cylinders being supplemented so as to form an entire figure when the cutting cylinders rotate in a synchronized manner and when suitably adjusted. The cutting threads correspond to the cutting patterns that intersect, as described above.

According to one particular embodiment of this cutting device, each cutting cylinder is a magnetic cylinder covered with a magnetizable flexible plate retained by magnetization forces, especially made of steel, bearing the cutting threads, which are electrochemically etched.

More particularly, this cutting device includes a base anvil cylinder.

The invention also relates to the device for manufacturing elements of relatively small size, especially such as planchettes, characterized in that it includes a reel holder, a printing device, with at least one printing unit, and a cutting device as described above.

According to one particular embodiment, this manufacturing device includes a printing device having at least two printing units with a set of bars for turning the sheet over between the units.

According to one particular embodiment, this manufacturing device includes a printing device having at least two printing units with a device for reversing the rotation of one of the printing units.

According to one particular embodiment, this manufacturing device includes, after the cutting device, a stripping device, in particular one using a peel bar and suction.

According to one particular embodiment, this manufacturing device includes an antistatic treatment device.

Examples of devices and methods of manufacturing elements of relatively small size according to the invention are described below.

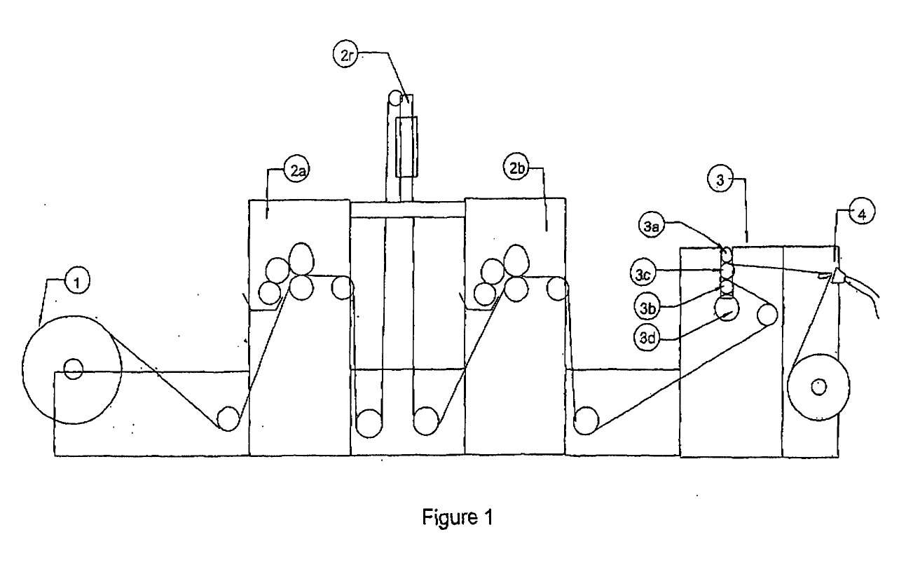

FIG. 1 shows schematically a manufacturing device according to the invention.

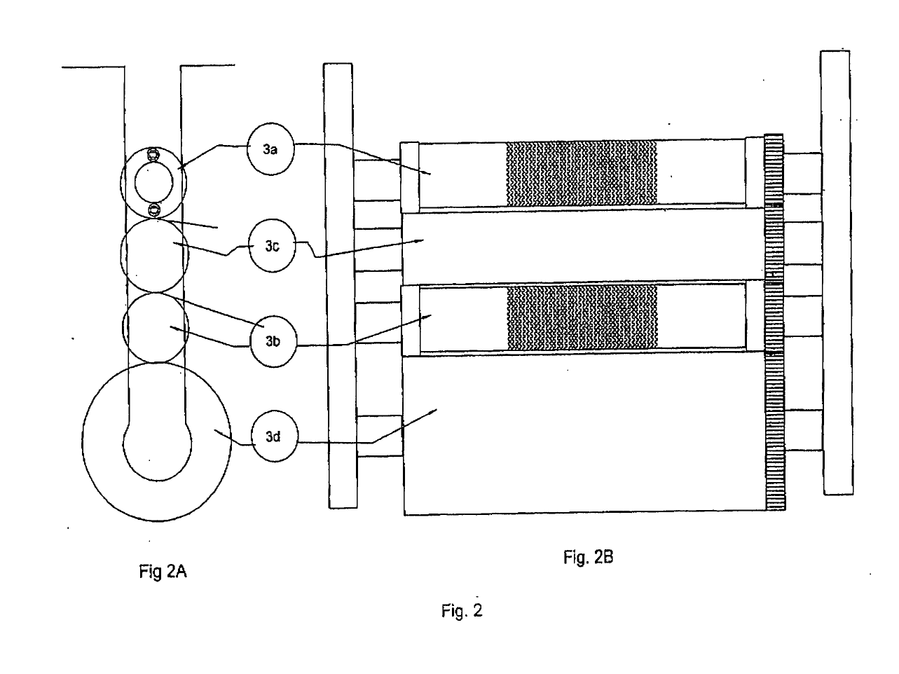

FIG. 2 shows the cylinders of the cutting device according to the invention, FIG. 2A being a side view of said cylinders and FIG. 2B being a detailed front view.

According to the exemplary embodiment shown in FIG. 1, in combination with FIG. 2, a manufacturing device comprises:
a reel holder with a reel (1) of overlay paper, consisting mainly of cellulose fibers and having a mean basis weight of 27 g/m²;
a printing device (2) comprising two flexography printing units (2a) and (2b) and a set of turn-over bars (2r);
a cutting device (3) comprising two cutting cylinders (3a) and (3b) between which is interposed an anvil cylinder (3c) and having a base anvil cylinder (3d), the cylinders being synchronized; and
a stripping device (4) using a peel bar and suction.

A detail of the cutting cylinders with the cutting patterns is shown in FIG. 2B. The patterns intersect so as to form a resulting pattern which is a disk (of the confetti type) which forms a detached element that will constitute a planchette.

The device shown in FIG. 1 can run at a speed of between 20 and 150 m/min.

The planchettes are manufactured as follows: the paper sheet is unwound, the upper side is printed with fluorescent inks in an amount of 3 g/m², in order to make a pattern representing a flag, the sheet is turned over by means of the turn-over bars and with front/back registration, and the other side is printed with the same pattern. The printing is dried by a UV radiation device. Other drying devices, for example hot-air or infrared drying devices, could be used.

The sheet is conveyed to the cutting device. It passes between the cutting cylinder (3a) and the anvil cylinder (3c) so as to deeply cut “right through” the paper according to the pattern borne by said cylinder (3a), it continues its path between the anvil cylinder (3c) and the cutting cylinder (3b) so as to deeply cut “right through” the paper according to the pattern borne by said cylinder (3b), which pattern crosses the first cutting pattern so as to form a detached element in the form of a disk. The screws (3e) make it possible to synchronize the cutting-plate-holder rolls so that the cutting threads form the pattern appropriately. The device allows a multitude of disks to be cut continuously from the sheet. The elements detached from the sheet (the disks) are recovered from the sheet by a stripping device using a peel bar and suction (4) and are then packaged.

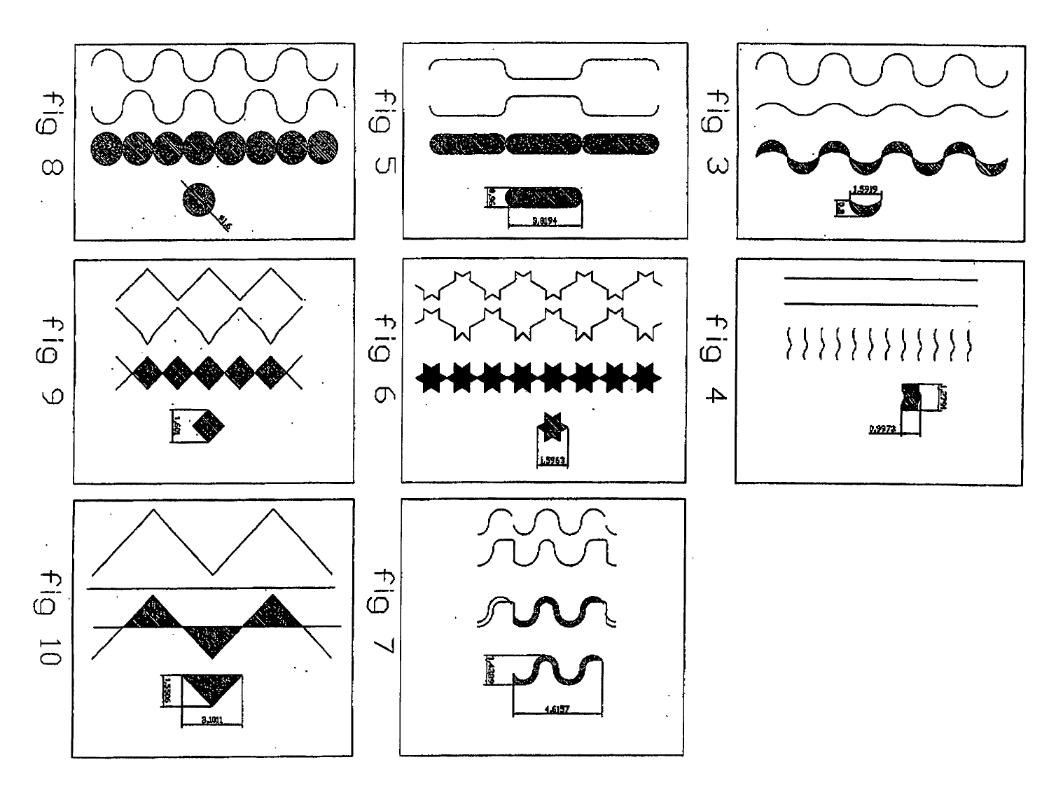

Examples of cutting patterns according to the invention which may intersect to form a detachable resulting pattern, and also the resulting pattern, are presented in FIGS. 3 to 10 of the plate of drawings 3/3. In each figure, the two first patterns represent the cutting patterns that will intersect, and the pattern below represents the resulting pattern, which will correspond to the element of relatively small size, for example a security planchette. The actual dimensions of the elements are indicated in millimeters in the figure.

The invention also aims to protect a security or decorative element of relatively small size, such as a security or decorative planchette, obtained using the manufacturing and/or cutting methods described above. The term “security element” is understood to mean any element for the purpose of providing security, such as the security elements conventionally used in security papers (papers of value, such as bank notes, checks, coupons, restaurant tickets or identity papers) but also those for other applications of security-protected papers associated with the hygiene and/or the medical field and/or associated with traceability, with the safety of personnel, such as for example in order to indicate a specific event, such as a date of expiry.

One use of the decorative elements may be to include them in sheets, especially paper sheets, in order to produce sheets with a decorative effect.

Preferably, said element has a thickness of between 50 and 110 μm.

More particularly, the invention aims to protect a security element obtained using the manufacturing and/or cutting methods described above and which includes identification patterns observable to the naked eye.

According to one particular embodiment, said security element includes patterns chosen from patterns that are visible in natural light or visible under UV light, that are luminescent, particularly fluorescent or phosphorescent, that are detectable by near or medium infrared radiation, that are thermochromic or piezochromic, that are based on DNA traces, that are optically variable, especially iridescent, or based on liquid crystals or on diffraction gratings or on moiré patterns or holograms, or that are electromagnetic, or combinations thereof.

More particularly, said security element includes, beneath or alongside said patterns, printing of electromagnetic, especially magnetic, character and in particular continuous tracks or codes in the form of magnetic bits.

According to one particular embodiment, said security element includes chemical authentication reactants or reactants that reveal a specific event. A specific event, it was mentioned above that this may for example be a date of expiry. It may also act as evidence of a break in a cold chain or evidence of sterilization.

The object of the invention is also to protect a security element as described above, the shape of said element (after being cut) being a security (authenticating) characteristic. This is because the elements may have novel and/or complex shapes that cannot be achieved with the prior techniques.

The object of the invention is also to protect a sheet having a fibrous substrate which includes said security or decorative element of relatively small size. In particular, the element includes a wetting agent and/or heat-sealing lacquer facilitating its incorporation and its retention in the fibrous substrate. The fibrous substrate may especially be obtained by a papermaking process starting from a suspension in aqueous medium of cellulose and/or synthetic fibers to which the elements of relatively small size have been added, using the known techniques for the planchettes of the prior art.

The invention therefore provides a security sheet that includes the security element as described above.

The invention also provides a decorative sheet that includes a decorative element obtained using the methods described above.

The sheet with said element may therefore be a conventional security sheet such as, for example, a bank note paper sheet or a check paper, but also security-protected sheet, that is to say a sheet for labels or a sheet for the medical or hospital fields.

The invention also relates to packaging that includes such a sheet with said element.

The invention also relates to a security document comprising, as base, a sheet having a fibrous substrate that includes at least one security element of relatively small size as described above.

This security document may for example be a bank note, a check, a restaurant ticket, a lottery ticket or a ticket for entry to cultural or sporting events.

The invention also provides a method of authenticating a security sheet, document or article that includes an element of small size as described above, using the shape of said element after it has been cut as security (authentication) characteristic. The shape may be recognized by the naked eye or by an optical recognition device, which may also make it possible to compare the observed shape with the reference shape stored in a memory of the device.

1. A method of manufacturing elements of relatively small size, especially such as planchettes, comprising the following steps:
a wound sheet is unwound, then
optionally, this sheet is printed at least partly on at least one side and then
the sheet is cut deeply “right through” along a succession of at least two cutting patterns that intersect so as to constitute a resulting pattern that will form a detached element constituting the element of relatively small size, this cutting operation taking place by means of a succession of synchronized cutting cylinders carrying one of the cutting patterns respectively, anvil cylinders being interposed between these cutting cylinders, the sheet passing between all these cylinders and
the detached elements that form said elements of relatively small size are recovered.

2. The method as claimed in claim 1, wherein the steps are carried out in line.

3. The method as claimed in claim 2, wherein it is carried out at a speed of between 20 and 150 m/min.

4. The method as claimed in claim 1, wherein said sheet is a sheet of paper, a sheet of nonwoven or a sheet of plastic, or a complex of these materials.

5. The method as claimed in claim 1, wherein the sheet is printed by flexography.

6. The method as claimed in claim 1, wherein the sheet is printed in an amount of 1 to 10 g/m² per side, preferably between 2 and 5 g/m2 per side.

7. The method as claimed in claim 1, wherein the sheet is printed on only one side.

8. The method as claimed in that claim 1, wherein the sheet is printed on both its sides in succession by front/back registration, in particular by turning the sheet over or by reversing the rotation of a printing unit.

9. The method as claimed in claim 1, wherein said sheet has a thickness of between about 5 and 110 μm.

10. The method as claimed in claim 1, wherein the detached elements are recovered by stripping, in particular using a peel bar and suction.

11. The manufacturing method as claimed in claim 1, wherein the largest dimension of the detached element is between 0.5 and 6 mm, preferably between 1 and 4 mm.

12. A method of cutting out elements of relatively small size, especially such as planchettes, wherein, starting from a sheet, said sheet is cut deeply “right through”, continuously, along a succession of at least two cutting patterns that intersect so as to constitute a resulting pattern that will form a detached element constituting the element of relatively small size, this cutting operation taking place using a succession of synchronized cutting cylinders carrying one of the cutting patterns respectively, anvil cylinders being interposed between these cutting cylinders.

13. A device for cutting out elements of relatively small size, especially such as planchettes, wherein it comprises a rotary cutting device comprising a succession of synchronized cutting cylinders having respective cutting threads, anvil cylinders being interposed between these cutting cylinders, the cutting threads on the cylinders being supplemented so as to form an entire figure when the cutting cylinders rotate in a synchronized manner and when suitably adjusted.

14. The cutting device as claimed in claim 13, wherein each cutting cylinder is a magnetic cylinder covered with a magnetizable flexible plate retained by demagnetization forces, especially made of steel, bearing the cutting threads, which are electrochemically etched.

15. The cutting device as claimed in claim 14, wherein it includes a base anvil cylinder.

16. A device for manufacturing elements of relatively small size, especially such as planchettes, wherein it includes a reel holder, a printing device, with at least one printing unit, and a cutting device described in claim 13.

17. The device as claimed in claim 16, wherein it includes a printing device having at least two printing units with a set of bars for turning the sheet over between the units.

18. The device as claimed in claim 16, wherein it includes a printing unit having at least two printing units with a device for reversing the rotation of one of the printing units.

19. The manufacturing device as claimed in claim 16, wherein it includes, after the cutting device, a stripping device, in particular one using a peel bar and suction.

20. The manufacturing device as claimed in claim 16, wherein it includes an antistatic treatment device.

21. A security element of relatively small size, wherein it is obtained using the manufacturing and/or cutting methods described in claim 1 and in that it includes identification patterns observable to the naked eye.

22. The security element as claimed in claim 21, wherein it includes patterns chosen from patterns that are visible in natural light, visible under UV light, luminescent patterns, particularly fluorescent or phosphorescent patterns, which are detectable by near or intermediate infrared radiation, thermochromic patterns, piezochromic patterns, patterns based on DNA tracers, patterns that are optically variable, especially iridescent or based on liquid crystals or diffraction gratings or moiré patterns or holograms, electromagnetic patterns, or combinations thereof.

23. The security element as claimed in claim 21, wherein it includes, beneath or alongside said patterns, printing of electromagnetic, especially magnetic, character and in particular continuous tracks or codes in the form of magnetic bits.

24. The security element as claimed in claim 21, wherein it includes chemical authentication reactants or reactants that reveal a specific event.

25. A security element of relatively small size, wherein it is obtained using the manufacturing and/or cutting methods described in claim 1, and wherein the shape of said element is a security characteristic.

26. A security sheet comprising a fibrous substrate which includes at least one security element of relatively small size obtained using the manufacturing and/or cutting methods described in claim 1.

27. A decorative sheet comprising a fibrous substrate, which includes at least one decorative element of relatively small size obtained using the manufacturing and/or cutting methods described in claim 1.

28. A security document comprising, as base, a sheet as claimed in claim 26.

29. A package comprising a sheet as claimed in claim 26.

30. A security element as claimed in claim 21, wherein the shape of said element is a security characteristic.

31. A security sheet comprising a fibrous substrate which includes at least one security element as described in claim 21.
